(19) United States
(12) Patent Application Publication
(10) Pub. No.: US 2023/0006492 A1
(43) Pub. Date: Jan. 5, 2023

(54) ALTERNATORS USING ALUMINUM WIRES IN STATOR ASSEMBLIES

(71) Applicants: S. UPPILI, Chennai (IN); Sreekanth NARASIMHAN, Tamil Nadu (IN); U. VIJAYALAKSHMI, Chennai (IN)

(72) Inventors: S. UPPILI, Chennai (IN); Sreekanth NARASIMHAN, Tamil Nadu (IN); U. VIJAYALAKSHMI, Chennai (IN)

(21) Appl. No.: 17/825,068

(22) Filed: May 26, 2022

(30) Foreign Application Priority Data
May 27, 2021 (IN) 202141023701

(51) Int. Cl. H02K 3/02; H02K 1/16; H02K 7/00; H02K 7/14

(52) U.S. Cl. CPC H02K 3/02; H02K 1/16; H02K 7/003; H02K 7/14

(57) ABSTRACT

An alternator for use in a vehicle comprises a stator assembly, a rotor, a casing, a shaft, an external fan, a first internal fan, and a second internal fan. The stator assembly comprises a stator frame and a stator winding wound on the stator frame. The stator winding is made of aluminum. The rotor is enclosed inside the stator assembly and has a first end and a second end. The second end is opposite the first end. The casing encloses the rotor and the stator assembly. The shaft is disposed in the casing with ends thereof extending beyond the casing. The shaft is rotatable about a fixed axis and the shaft having the rotor fixedly disposed thereon. The external fan is mounted on the shaft and is disposed outside the casing. The first internal fan is mounted on the shaft and is disposed inside the casing at the first end of the rotor. The second internal fan is mounted on the shaft and is disposed inside the casing at the second end of the rotor.

### TECHNICAL FIELD

The present subject matter relates, in general, to alternators, and in particular, alternators using aluminum wires in stator assemblies for automotive engines and stationary engines.

### BACKGROUND

Alternators are a type of Alternating current (NC) generators and are used to charge batteries in automotive engines and stationary engines, such as generator sets (GENSETs). The alternator is coupled to an engine and converts rotational energy to electrical energy which is provided to a battery. Further, the battery uses the power obtained from the alternator to power various sources in automotive applications and stationary engines.

### BRIEF DESCRIPTION OF THE DRAWINGS

The features, aspects, and advantages of the present subject matter will be better understood with regard to the following description and accompanying figures. The use of the same reference number in different figures indicates similar or identical features and components.

FIG. 1 illustrates a cross-sectional view of an alternator, in accordance with an implementation of the present subject matter;

FIG. 2 illustrates an alternator with a part of casing removed, in accordance with an implementation of the present subject matter;

FIG. 3a illustrates a stator assembly of an alternator wound with an aluminum enameled wire, in accordance with an implementation of the present subject matter;

FIG. 3b illustrates a stator assembly of an alternator wound with an aluminum enameled wire and a stator of a conventional alternator wound with a copper enameled wire, in accordance with an implementation of the present subject matter; and

FIG. 4a-4f illustrate welding of a stator assembly and a rectifier of an alternator, in accordance with an implementation of the present subject matter.

### DETAILED DESCRIPTION

Alternators are coupled to an engine to receive rotational torque from the engine and convert rotational energy to electrical energy. The electrical energy is provided to a battery, which is used to power various sources in automotive applications and stationary engines. An alternator, typically, includes a rotor, a stator, a shaft, a regulator, and a rectifier. The rotor rotates about a fixed axis and includes a coil (referred to as rotor windings) wound around a rotationally disposed iron core. The stator surrounds the rotor and is fixed and is formed by a set of copper coils (hereinafter referred to as stator windings) wound around a fixed core.

The shaft is coupled to the rotor and is rotatable about the fixed axis to rotate the rotor with respect to the stator. A pulley is mounted on the shaft and a belt is mounted on the pulley which is coupled to an engine. During running of the engine, the pulley is rotated by a belt which causes the shaft and the rotor to rotate. As the rotor rotates with respect to the stator windings, a magnetic field, caused due to magnetic poles of the rotor, cuts through the stator windings, varying as it so does, producing electrical current in the stator windings which is of alternating nature, i.e., an alternating current (NC), owing to the variation in the magnetic field. To power components in applications, such as automobiles, the NC output may have to be converted to direct current (D/C) using, for example, a rectifier. Further, a regulator may regulate an output voltage of the alternator and the alternator include a fan to cool the stator during operation of the alternators.

In the conventional alternators, the stator windings are made of copper. This is because copper has high conductivity and low resistivity. However, copper is an expensive material and the usage of copper for the stator windings increases the cost of the alternators. Further, copper, being a high-grade material, may not have to be used to meet the requirements for an alternator, and may be reserved for other applications, such as for applications related to alternative source of energy.

Materials, such as enameled aluminum, may be used as an alternative to copper for stator winding wires. However, since aluminum has conductivity less than that of copper, such as only 61% of the conductivity of copper, a larger diameter of aluminum may have to be used to compensate for the loss in conductivity. For instance, resistivity of copper 1.68×10⁻⁸ ohm and that of aluminum is 2.85×10⁻⁸ ohm. Hence, to obtain a resistance same as that of 1 mm diameter of copper wire, aluminum wire of diameter 1.3 mm may have to be used. However, such increase in size of stator winding wires may cause an increase in the overall size of the alternator. As a result, the weight of the alternator increases.

Further, the winding wires are wound in specialized slots created in the stator. In the conventional alternators that use copper as stator winding wires, a slot fill factor in stator with copper winding wires is around 80%, i.e., 80% of the slot is filled with copper. However, since the cross section of aluminum wire to be used is higher than that of the copper wire, it may be difficult to accommodate the aluminum wire in the specialized slots of the stator. For instance, cross sectional area for 1 mm diameter copper wire is 0.785 Sq. mm while cross-sectional area of the 1.3 mm diameter aluminum wire is 1.324 Sq. mm. Therefore, aluminum wire having the same resistance as that of the copper wire has a cross-sectional area that is 1.7 times more than that of copper wire, which may be difficult to be accommodated in the existing stator slots. Therefore, if aluminum wire is to be used as the stator winding wire, a larger slot may have to be used for the winding wires. This may further cause an increase in the size of stator.

Furthermore, since the heat resistivity of aluminum is higher, the heat generated of the aluminum may be higher than that of copper. The increase in heat generation may reduce the efficiency and performance of the alternator. The performance of the alternator is defined by an output current at a specified voltage and a specified RPM of the alternator.

The present subject matter relates to alternators for use in vehicles and that use aluminum wires in stator assemblies. With the implementations of the present subject matter, aluminum can be used as stator wire in the alternators without increasing the size of the stator slot, and thereby, without increasing the size of the alternator. The alternator may include a stator assembly, a rotor, a casing, and a shaft. The stator assembly is fixed, i.e., does not rotate, and includes a stator frame and a stator winding that is wound on the stator frame. The stator windings, as mentioned above, are made of aluminum.

The rotor is enclosed inside the stator. The rotor has a first end and a second end. The second end is opposite the first end. The rotor rotates about a fixed axis. The casing may enclose both the rotor and the stator assembly. The shaft is disposed in the casing with the ends of the shaft extending beyond the casing. The rotor is fixedly disposed on the shaft and the shaft is rotatable about the fixed axis. Therefore, as the shaft rotates, the rotor also rotates. In an example, a pulley may be disposed on the shaft and may be connected to an engine of the vehicle through a belt. During the operation of the engine, the shaft is rotated by the engine through the belt and the pulley arrangement. This rotates the rotor. The rotation of the rotor may cause production of output voltage in the stator.

The alternator may include an external fan mounted on the shaft and disposed outside the casing and may include, disposed internal to the casing, a first internal fan and a second internal fan. The first internal fan may be mounted on the shaft and may be disposed inside the casing at a first end of the rotor. The second internal fan may be mounted on the shaft and may be disposed inside the casing. During operation, large amount of heat may be generated due to heating of the aluminum stator windings. With the provision of three fans, i.e., one external fan and two internal fans, the heat generated in the aluminum windings is effectively dissipated.

Further, by effectively dissipating the heat generated by aluminum winding and providing cooling, the conductivity of the aluminum is increased. Therefore, with the present subject matter, aluminum winding with diameter and thereby, cross-sectional area, same as that of copper winding used in conventional alternators, can be used to obtain same performance as that of the conventional alternators. The present subject matter eliminates the usage of copper wire for stator winding. Therefore, the present subject matter eliminates the problems associated with usage of copper for the stator windings, such as high cost and the difficulty in availability of copper. At the same time, since the same cross-sectional size of the aluminum windings as that of the conventional copper windings is usable, the present subject matter ensures that the same stator used in conventional alternators can be used for in the alternator of the present subject matter, in other words, without requiring additional tooling and cost for manufacturing the stator. Further, the cost of aluminum is lesser than that of copper and the usage of aluminum winding results in substantial savings of costs.

In addition, the weight of the aluminum winding is less than that of the copper winding of same specification. For instance, aluminum winding is one-third the weight of the copper winding of same specification. Therefore, by replacing the copper winding with aluminum winding, weight of the alternator reduces which cause reduction in the weight of the engine and the fuel efficiency of the engine is enhanced.

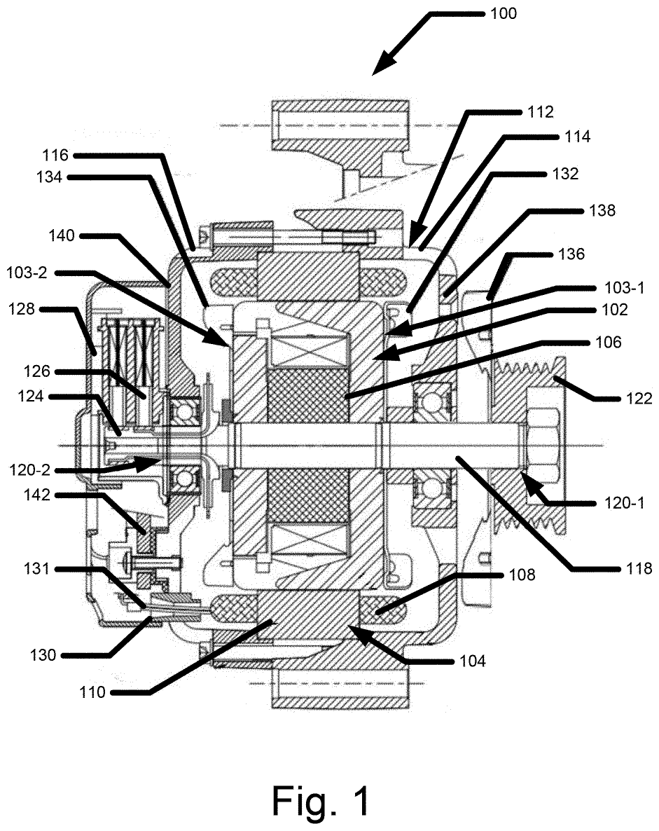

The present subject matter is further described with reference to FIGS. 1-4f. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a cross-sectional view of an alternator 100. The alternator 100 may be used for a vehicle. Hereinafter, the alternator 100 may be explained with reference to usage in a vehicle. The alternator 100 may include a rotor 102 and a stator assembly 104. The rotor 102 may include a coil of wire wound (hereinafter referred to as “rotor winding”) around a rotor core 106. The rotor core 106 may be made of iron. Current flowing through the rotor winding (hereinafter referred to as “field current”) produces a magnetic field around the rotor core 106. The field current is a direct current (D/C). The rotor 102 may rotate about a fixed axis. The rotor 102 may have a first end 103-1 and a second end 103-2. The second end 103-2 may be opposite the first end 103-1.

The stator assembly 104 may surround the rotor 102 and may be fixed, i.e., the stator assembly 104 does not rotate. The stator assembly 104 may include a stator winding 108 and a stator frame 110. The stator winding 108 may be wound on the stator frame 110. As the rotor 102 rotates within the stator winding 108, the magnetic field of the rotor 102 cuts through the stator winding 108, varying as it so does, producing electrical current in the stator winding 108, which is of alternating nature. In other words, an alternating current (NC), owing to the variation in the magnetic field, may be produced. In an example, the stator winding 108 may be made of aluminum. In an example, the diameter of the stator frame 110 may be at least 100 millimeter (mm) and the diameter of the stator winding 108 is at least 1.4 mm.

The alternator 100 may include a casing 112. The casing 112 may enclose the rotor 102 and the stator assembly 104. In an example, the casing 112 may include a first member 114 and a second member 116. The first member 114 and the second member 116 may be bolted together. The first member 114 may include a first opening (not shown in FIG. 1) and the second member 116 may include a second opening (not shown in FIG. 1).

The alternator 100 may include a shaft 118 on which the rotor 102 is mounted. The shaft 118 may be disposed with ends 120-1, 120-2 of the shaft 118 extending beyond the casing. 112. Particularly, a first end 120-1 of the shaft 118 may extend out of the casing 112 through the first opening and a second end 120-2 of the shaft 118 may extend out of the casing 112 through the second opening. The shaft 118 may be rotatably supported by the casing 112 by a plurality of brackets (not shown in FIG. 1).

The alternator 100 may be coupled to an engine (not shown in FIG. 1) of the vehicle by a belt (not shown in FIG. 1) and a pulley 122. The pulley 122 may be disposed on and fastened to the shaft 118 on a first end of the alternator 100 (hereinafter referred to as drive end (DE) side). Therefore, during running of the engine, the engine may transfer rotational torque to the rotor 102. For instance, the engine may cause the belt and the pulley 122 to rotate, which causes the shaft 118 and the rotor 102 to rotate.

The alternator 100 may include slip rings 124 on an end of the alternator 100. Particularly, the slip rings 124 may be fastened to the second end 120-2 of the shaft 118. An end (i.e., a second end) of the alternator 100 where the slip rings 124 are disposed may be referred to as the slip ring end (SRE) side. As will be understood, the drive end side is opposite to the SRE side. Further, a pair of brushes 126 may be housed in a brush holder (not shown in FIG. 1) disposed inside the casing 112 such that the pair of brushes 126 slide in contact with the slip rings 124 to supply electric current to the rotor 102.

The alternator 100 may include a regulator 128 to regulate the output voltage of the alternator 100. The regulator 128 has two inputs and one output. The inputs are field current supply and a control voltage input, and the output is the field current to the rotor 102. The regulator 128 may use the control voltage input to control the amount of field current input that is allowed to pass through to the rotor winding. The regulator 128 is coupled to a battery (not shown in FIG. 1). If a voltage of the battery drops, the regulator 128 senses this and allows more of the field current input to reach the rotor 102, which increases the magnetic field strength, thereby increasing the voltage output of the alternator 100. Conversely, if the battery voltage goes up, less field current goes through to the rotor windings, and the output voltage is reduced.

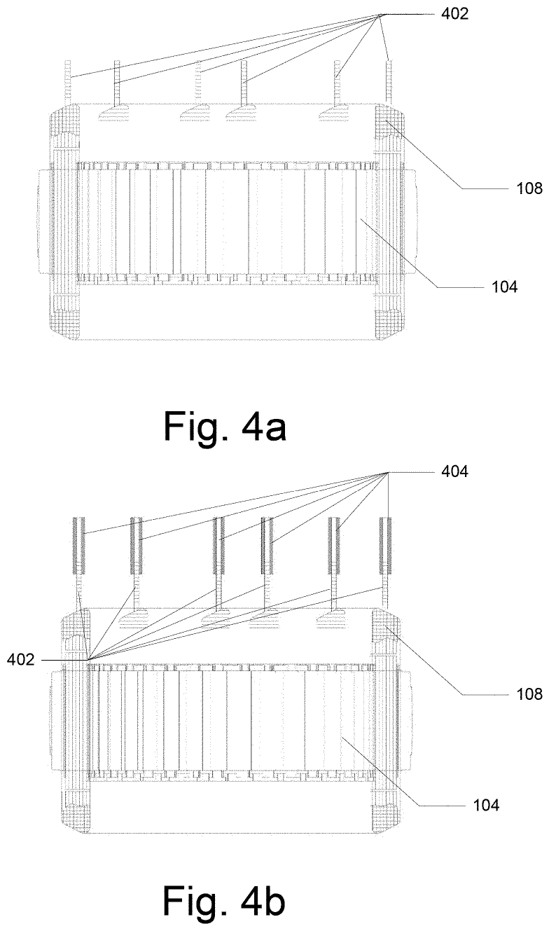

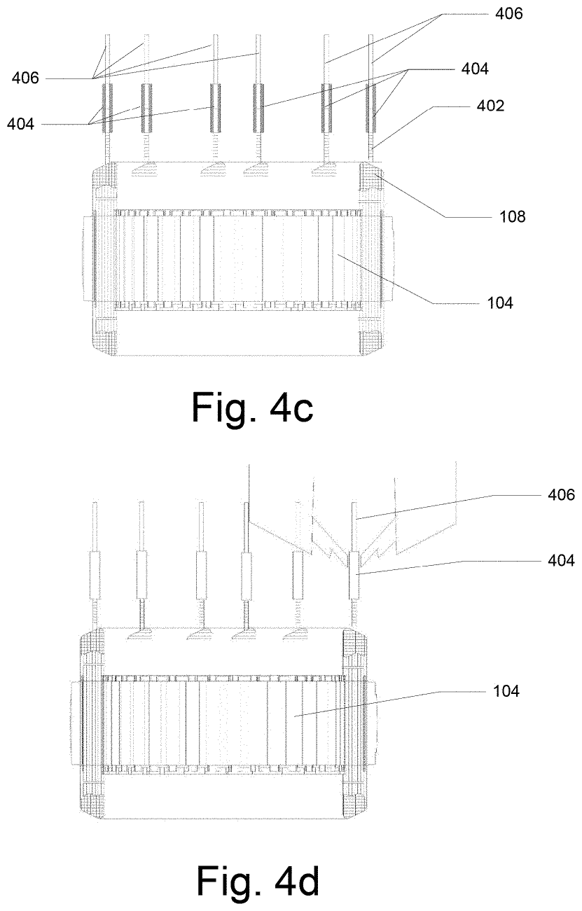

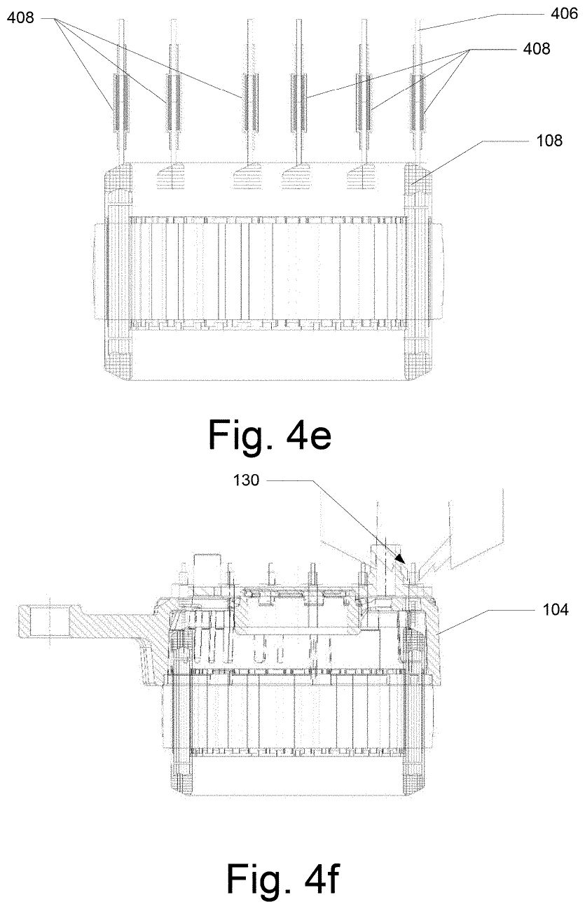

The alternator 100 includes a rectifier 130 to convert NC output induced in the stator assembly 104 to direct current (D/C) output and thereby, may be used to power components in the vehicle. In an example, the rectifier 130 may include a plurality of diodes for instance, six diodes, i.e., a pair for each stator winding 108. The rectifier 130 may include a rectifier wiring 131. The rectifier wiring 131 may be, for example, made of copper. The lead wires from the stator winding 108 may have to be coupled to the rectifier wiring 131 so that the rectifier 130 converts the NC output voltage from the stator assembly 104 to D/C. Since, the rectifier wiring 131 and the stator winding 108 may be made of different materials, such as copper and aluminium respectively, the rectifier wiring 131 and the stator winding 108 may not be connected directly. In an example, a connector (not shown in FIG. 1) may be used to connect the rectifier wiring 131 and the stator winding 108. For instance, one end of the connector may be welded with a copper lead and another end of the connector may be welded with a lead wire of the stator wiring. Further, the copper lead may be connected with the rectifier wiring 131, as will be described with reference to FIGS. 4a-4f.

The alternator 100 may include a first internal fan 132 and a second internal fan 134 for cooling the stator assembly 104 during the operation of the alternator 100. The first internal fan 132 and the second internal fan 134 may be mounted on the shaft 118. The first internal fan 132 may be disposed inside the casing 112 at the first end 103-1 of the rotor 102. The second internal fan 134 may be disposed inside the casing 112 at the second end 103-2 of the rotor 102. In an example, the first internal fan 132 may be provided near to the DE side than to the SRE side of the alternator 100 and the second internal fan 134 may be provided near to the SRE side than to the DE side. During the operation, large amount of heat may be generated due to heating of aluminum. Accordingly, to cool the alternator 100, in addition to the internal fans 132, 134, the alternator 100 may include an external fan 136. The external fan 136 may be mounted on the shaft 118 and may be disposed outside the casing 112. The external fan 136 may be mounted near to the DE side than to the SRE side. In an example, the external fan 136 may be tightened to the shaft 118 using a bracket or a spacer. With the provision of three fans, i.e., two internal fans 132, 134 and one external fan 136, the heat generated in the aluminum stator winding 108 may be effectively dissipated. Further, by effectively dissipating the heat generated in the stator winding 108 and providing cooling, the conductivity of the Aluminum is increased. Therefore, the performance of the alternator of the present subject matter is same, or in some cases, even better than the conventional alternators.

The alternator 100 may include a drive end (DRE) bracket 138 disposed on the DRE side of the alternator and an SRE bracket 140 disposed on the SRE side of the alternator 100 to support the rotor 102 and the stator assembly 104. Further, the alternator 100 may include a heat sink 142 for taking the heat away from the alternator 100 during the operation of the alternator 100.

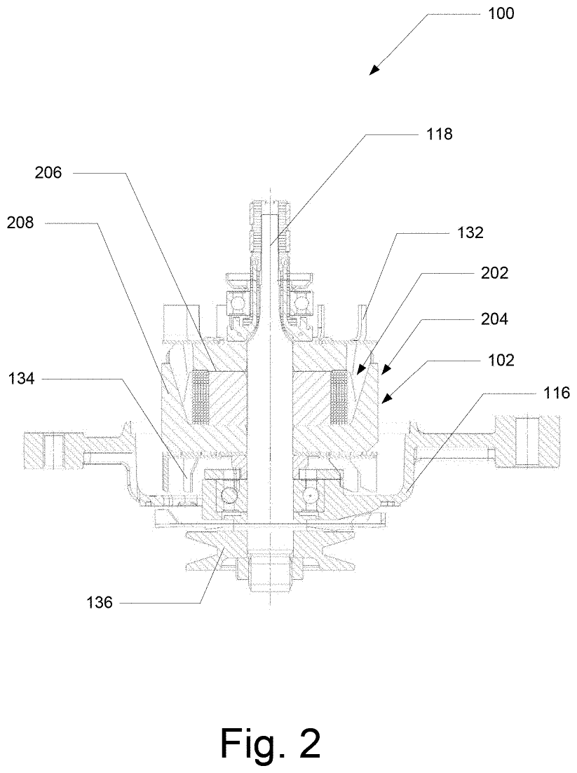

FIG. 2 illustrates an alternator 100 with a part of casing 112 removed, in accordance with an implementation of the present subject matter. In the view depicted herein, the first member 114 of the casing 112 is removed. The rotor 102 may include a first rotor pole 202 and a second rotor pole 204 for generating magnetic flux on passage of electric current. The first rotor pole 202 may include a first plurality of magnetic poles 206. The second rotor pole 204 may include a second plurality of magnetic poles 208. Each of the first plurality of magnetic poles 206 and each of the second plurality of magnetic poles 208 may be spaced at a distance along a circumferential direction. In an example, the magnetic poles 206, 208 may be disposed at even pitch in a circumferential direction to project axially. The first rotor pole 202 and the second rotor pole 204 may be, for example, claw-shaped. That is, between two magnetic poles of the first plurality of magnetic poles 206, there may be a valley portion. Similarly, between two magnetic poles of the second plurality of magnetic poles 208, there may be a valley portion. The rotor poles 202, 204 may be fastened to the shaft 118 facing each other such that the first plurality of magnetic poles 206 and the second plurality of magnetic poles 208 intermesh, as can be seen in FIG. 2. That is, each of the first plurality of magnetic poles 206 may be disposed in a valley portion of the second rotor pole 204. Similarly, each of the second plurality of magnetic poles 208 may be disposed in a valley portion of the second rotor pole 204.

In an example, the first internal fan 132 and the second internal fan 134 may be coupled to the first rotor pole 202 and the second rotor pole 204 respectively on either side of the poles 202, 204. In an example, the first internal fan 132 may be welded to the first rotor pole 202 and the second internal fan 134 may be coupled to the second rotor pole 204 using spacers (not shown in FIG. 2).

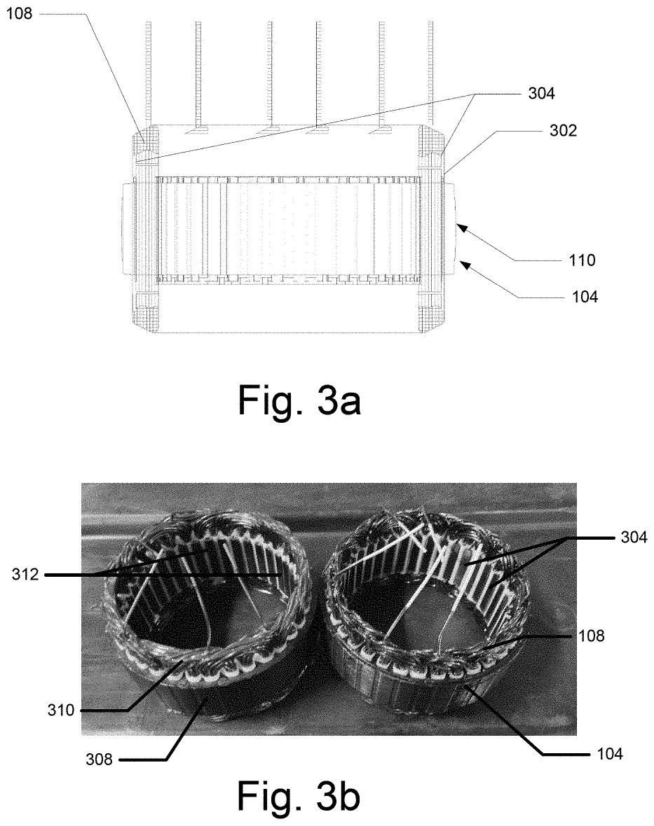

FIG. 3a illustrates the stator assembly 104 wound with an aluminum enameled winding, in accordance with an implementation of the present subject matter. The stator frame 110 may be, for example, cylindrical in shape. The stator frame 110 may include a laminated core 302 formed with a plurality of slots 304. Each slot 304 extends axially in a circumferential direction. As will be understood, the number of slots 304 housing the winding corresponds to the number of magnetic poles 206, 208 (not shown in FIG. 3a) in the rotor 102. The stator winding 108 is wound in each slot 304. The stator winding 108 may, for example, have a circular cross section.

FIG. 3b illustrates the stator assembly 104 wound with the aluminum enameled winding 108 and a stator assembly 308 of a conventional alternator wound with a copper enameled winding 310, in accordance with an implementation of the present subject matter. As can be seen from FIG. 3b, the size of slots 312 of the stator assembly 308 having the copper enameled winding 310 is same as the size of slots 304 of the stator assembly 104 wound with the aluminum enameled winding 108. Similarly, the size of the stator assemblies 104 and 308 is also same. Therefore, in the present subject matter, stator assemblies 308 used in the conventional alternators can be used by replacing the copper winding with the aluminum winding.

FIG. 4a-4f illustrate welding of the stator assembly 104 and the rectifier 130, in accordance with an implementation of the present subject matter. The FIGS. 4a-4f depict the steps involved in welding the stator with the rectifier.

Initially, as depicted in FIG. 4a, the lead wires 402 of the stator winding 108 may be de-enameled to enable welding of the stator winding 108 with the rectifier 130. For instance, it may not be possible to obtain a proper weld of the stator winding 108 with the rectifier 130 with enameling in the lead wires 402. Subsequently as depicted in FIG. 4b, a connector 404 is inserted with a lead wire 402 of the stator winding 108. One end of the connector 404 (hereinafter referred to as “first end”) is welded with the lead wire 402 of the stator winding 108 to form a first welded portion. The connector 404 may be, for example, made of copper. In an example, the welding may be, for example, resistance welding. Similarly, a connector 404 may be inserted and welded to each of the lead wire 402 of stator winding 108.

Subsequently, as depicted in FIG. 4c, a copper lead wire 406 may be inserted into another end of the connector 404 (hereinafter referred to as “the second end”), as is shown in FIG. 4c. Further, the copper lead wire 406 may be welded to the second end of the connector 404 to form the second welded portion, as is shown in FIG. 4d. The welding may be, for example, resistance welding. Similarly, a copper lead wire 406 is inserted and welded with each of the connectors 404.

Aluminum is susceptible for getting rusted due to salt corrosion. In automobile applications, due to unsuitable environmental conditions, the stator winding 108 may get rusted and thereby, resulting in malfunction of the alternator 100. Accordingly, to protect the lead wires 402 of the stator winding 108 from exposure to environment, the alternator 100 may include a heat shrink sleeve 408. The heat shrink sleeve 408 may be inserted such that the heat shrink sleeve 408 may cover the first welded portion, the connector 404, and the second welded portion. As can be seen in FIG. 4e, the alternator 100 may include a plurality of heat shrink sleeves 408, where each heat shrink sleeve 408 is used corresponding to a lead wire 402. That is, a heat shrink sleeve 408 may be inserted to cover the first welded portion, a connector 404, and the second welded portion corresponding to each lead wire 402 of the stator winding 108. As hot air is blown over each of the heat shrink sleeves 408, the heat shrink sleeves 408 shrink and gets attached to and may cover the first welded portion, a connector 404, and the second welded portion corresponding to each lead wire 402 of the stator winding 108.

Finally, the rectifier 130 may be welded with the stator assembly 104, as can be seen in FIG. 4f. For instance, the copper lead wires 406 welded to the connector 404 may be connected to the rectifier wiring 131 (not shown in FIG. 4f).

Although, in the above examples, the alternator is explained with reference to usage in a vehicle, in other examples, the alternator of the present subject can be used in applications, such as stationary engines.

### Examples

The performance of the alternator 100 of the present subject matter with the aluminum winding and that of the conventional alternators with the copper winding of same specifications was compared. The performance of the alternator is defined by an output current supplied by the alternator at a specified voltage and a specified RPM of the alternator.

The alternators were allowed to be operated for a stipulated time, such as a stabilization time, where the alternator heats up and reaches stabilized heat conditions. The performance parameters of the alternators are listed at the stabilized heat conditions in the below tables. In the examples shown below, the stabilization time was 20 minutes. The stator frame 110 of the alternator 100 of the present subject matter and of the conventional alternator used were of diameter 100 mm. Further, the diameter of the aluminum winding of the stator winding 108 of the present subject matter and the diameter of the copper of the stator winding of the conventional alternator were 1.4 mm. Further, the alternator 100 and the conventional alternator had 8 turns in the stator winding 108.

TABLE 1A
Performance of a conventional alternator with
enameled copper winding stator for a 3-wheeler

| | Current | | Current | Temperature |
|---|---|---|---|---|
| Speed | Spec | Voltage | achieved | measured on |
| (RPM) | (Ampere) | (Volt) | (Ampere) | stator core (° C.) |
| 3200 | 29 | 13.4 | 32.7 | 118 |
| 3840 | 31 | 14 | 34.3 | 127 |
| 5760 | 34.5 | 14 | 34.9 | 113 |
| 6000 | 35 | 13.9 | 38.8 | 116 |

TABLE 1B
Performance of the alternator 100 of the present subject matter
with enameled aluminum winding stator for a 3-wheeler

| | Current | | Current | Temperature |
|---|---|---|---|---|
| Speed | Spec | Voltage | achieved | measured on |
| (RPM) | (Ampere) | (Volt) | (Ampere) | stator core (° C.) |
| 3200 | 29 | 14.1 | 31.8 | 69 |
| 3840 | 31 | 13.4 | 37.6 | 70 |
| 5760 | 34.5 | 13.7 | 43.6 | 60 |
| 6000 | 35 | 13.7 | 44.5 | 53 |

To compare the performance of the alternators, let us take the case of speed of 6000 RPM. For the aforementioned speed, the current that is expected to be produced by the alternators is 31 amps. The current output of the conventional alternator with enameled copper winding stator is 38.8 amps with a temperature of 116° C. For the same speed, the current output of the alternator of the present subject matter is 44.5 Amp which is higher than the specified current with a temperature of 53° C. (Table 1B). This indicates that an improved cooling efficiency is obtained with the alternator 100 of the present subject matter. Further, the performance of the alternator of the present subject matter with an enameled aluminum winding matches the performance of the alternator with copper without having to use higher cross-section area of aluminum to compensate for the conductivity of copper winding. Thus, the same performance characteristic can be achieved with the alternator 100 of the present subject matter having the same stator configuration as the stator of the conventional alternator.

TABLE 2A
Performance of a conventional alternator with
enameled copper winding stator for a 4-wheeler

| | Current | | Current | Temperature |
|---|---|---|---|---|
| Speed | Spec | Voltage | achieved | measured on |
| (RPM) | (Ampere) | (Volt) | (Ampere) | stator core (° C.) |
| 2000 | 21 | 13.2 | 23.5 | 104 |
| 3000 | 32 | 13.4 | 36 | 123 |
| 5000 | 42 | 13.6 | 46 | 156 |
| 6000 | 50 | 13.9 | 52 | 182 |

TABLE 2B
Performance of an alternator 100 of the
present subject matter for a 4-wheeler

| | Current | | Current | Temperature |
|---|---|---|---|---|
| Speed | Spec | Voltage | achieved | measured on |
| (RPM) | (Ampere) | (Volt) | (Ampere) | stator core (° C.) |
| 2000 | 21 | 13.2 | 22.5 | 85 |
| 3000 | 32 | 13.4 | 34.6 | 83 |
| 5000 | 42 | 13.6 | 44.6 | 82 |
| 6000 | 50 | 13.9 | 50.2 | 80 |

TABLE 3A
Hot stabilized performance of a conventional alternator
with enameled copper winding stator for a 4-wheeler

| | Current | | Current | Temperature |
|---|---|---|---|---|
| Speed | Spec | Voltage | achieved | measured on |
| (RPM) | (Ampere) | (Volt) | (Ampere) | stator core (° C.) |
| 2000 | 55 | 13.2 | 59.5 | 138 |
| 3000 | 60 | 13.4 | 63 | 140 |
| 5000 | 65 | 13.6 | 71 | 142 |
| 6000 | 75 | 13.8 | 81 | 113 |

TABLE 3B
Hot stabilized performance of an alternator 100 of the present subject
matter with enameled aluminum winding stator for a 4-wheeler

| | Current | | Current | Temperature |
|---|---|---|---|---|
| Speed | Spec | Voltage | achieved | measured on |
| (RPM) | (Ampere) | (Volt) | (Ampere) | stator core (° C.) |
| 2000 | 55 | 13.2 | 58.5 | 116 |
| 3000 | 60 | 13.4 | 61 | 112 |
| 5000 | 65 | 14 | 65.4 | 104 |
| 6000 | 75 | 14.1 | 70.9 | 89 |

As can be seen in Tables 2A, 2B, 3A, and 3B, the current output of the alternator 100 of the present subject matter matches or, in some cases, is even better than the current output of the conventional alternator. Thus, the same performance characteristic can be achieved with the alternator of the present subject matter having the same stator configuration as the stator of the conventional alternator. Further, an improved cooling efficiency is obtained with the alternator of the present subject matter. The present subject matter, by improving the cooling efficiency, also improves the efficiency of the engine.

With the provision of three fans, i.e., one external fan and two internal fans, the heat generated in the aluminum windings is effectively dissipated.

Further, by effectively dissipating the heat generated by aluminum winding and providing cooling, the conductivity of the aluminum is increased. Therefore, with the present subject matter, aluminum winding with diameter and thereby, cross-sectional area, same as that of copper winding used in conventional alternators, can be used to obtain same performance as that of the conventional alternators. The present subject matter eliminates the usage of copper wire for stator winding. Therefore, the present subject matter eliminates the problems associated with usage of copper for the stator windings, such as high cost and the difficulty in availability of copper. At the same time, since the same cross-sectional size of the aluminum windings as that of the conventional copper windings is usable, the present subject matter ensures that the same stator used in conventional alternators can be used for in the alternator of the present subject matter, in other words, without requiring additional tooling and cost for manufacturing the stator. Further, the cost of aluminum is lesser than that of copper and the usage of aluminum winding results in substantial savings of costs.

In addition, the weight of the aluminum winding is less than that of the copper winding of same specification. For instance, aluminum winding is one-third the weight of the copper winding of same specification. Therefore, by replacing the copper winding with aluminum winding, weight of the alternator reduces which cause reduction in the weight of the engine and the fuel efficiency of the engine is enhanced.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

I/We claim:

1. An alternator for use in a vehicle comprising:
a stator assembly comprising:
a stator frame;
a stator winding wound on the stator frame, wherein the stator winding is made of aluminum;
a rotor enclosed inside the stator assembly, wherein the rotor has a first end and a second end, wherein the second end is opposite the first end;
a casing enclosing the rotor and the stator assembly;
a shaft disposed in the casing with ends thereof extending beyond the casing, wherein the shaft is rotatable about a fixed axis, the shaft having the rotor fixedly disposed thereon;
an external fan mounted on the shaft and disposed outside the casing;
a first internal fan mounted on the shaft and disposed inside the casing at the first end of the rotor; and
a second internal fan mounted on the shaft and disposed inside the casing at the second end of the rotor.

2. The alternator as claimed in claim 1, comprising:
a connector having a first end and a second end, wherein the first end is welded to the stator winding to form a first welded portion, and wherein the second end is welded to a copper lead wire to form a second welded portion; and
a heat shrink sleeve enclosing the first welded portion, the connector, and the second welded portion.

3. The alternator as claimed in claim 2, comprising:
a rectifier to convert alternating current produced in the stator assembly to direct current, wherein the rectifier comprises rectifier wiring, wherein the rectifier wiring is connected to the copper lead wire.

4. The alternator as claimed in claim 2, wherein the connector is made of copper.

5. The alternator as claimed in claim 1, wherein a diameter of the stator frame is at least 100 millimeter.

6. The alternator as claimed in claim 1, wherein diameter of the stator winding is at least 1.4 millimeter.

7. The alternator as claimed in claim 1, wherein the rotor comprises:
a first rotor pole comprising a first plurality of magnetic poles, wherein each of the first plurality of magnetic poles are spaced at a distance along a circumferential direction; and
a second rotor pole comprising a second plurality of magnetic poles, wherein each of the second plurality of magnetic poles are spaced at a distance along the circumferential direction,
wherein the first internal fan is coupled to the first rotor pole and the second internal fan is coupled to the second rotor pole.

8. The alternator as claimed in claim 7, wherein the first rotor pole and the second rotor pole are claw-shaped.

9. The alternator as claimed in claim 1, comprising a first end and a second end, wherein the second end is opposite to the first end, wherein the external fan is mounted near to a first end of the alternator than to a second end of the alternator, and wherein the external fan is tightened to the shaft through one of: a bracket, and a spacer.

10. The alternator as claimed in claim 1, wherein:
a pulley mounted on the shaft at a first end of the alternator;
a belt is disposed on the pulley and is coupled to an engine of the vehicle, wherein the engine is to provide a rotational torque to the shaft through the belt and the pulley, and wherein the rotation of the shaft causes the rotation of the first internal fan, the second internal fan, and the external fan.
